(19) United States
(12) Patent Application Publication
(10) Pub. No.: US 2007/0177548 A1
(43) Pub. Date: Aug. 2, 2007

(54) Call control system

(75) Inventors: Takuji Oyama, Kawasaki (JP); Hidehiko Suzuki, Kawasaki (JP); Tatsuhiro Ando, Kawasaki (JP); Yoshihiro Kubota, Kawasaki (JP)

Correspondence Address: BINGHAM MCCUTCHEN LLP, 2020 K Street, N.W., Intellectual Property Department, WASHINGTON, DC, 20006, US

(73) Assignee: FUJITSU LIMITED

(21) Appl. No.: 11/603,122

(22) Filed: Nov. 22, 2006

(30) Foreign Application Priority Data
Feb. 2, 2006 (JP) JP2006-025651

(51) Int. Cl. H04Q 7/00

(52) U.S. Cl. 370/331; 455/456.1

(57) ABSTRACT

To provide a technology of setting up a call at a high efficiency by a location management device's sending notification of a call setup request to a call control device corresponding to a location of a callee communication device. A call control device connected to a location management device via a network receives a call setup request, searches a location data table for location information of a callee communication device in response to the call setup request, sets up, when the location information is searched out as a result of the search, a call on the basis of the location information, and notifies, when the location information is not searched out as the result of the search, the location management device of the call setup request. The location management device receives notification of a call setup request from the call control device, refers to a storage unit stored with management information specifying which call control device controls the call targeted at each callee communication device, and notifies, of the call setup request, the call control device that controls the call to the callee communication device at which the call setup request is targeted on the basis of the management information referred to.

### BACKGROUND OF THE INVENTION

The invention relates to a technology of setting up a call between communication terminals, corresponding to a location of the communication terminal.

Over the recent years, so-called IP telephony has spread, wherein a call between communication terminals is set up via an IP network such as the Internet, and a mobile talk is conducted by transmitting and receiving voice packets on the basis of the Internet Protocol (IP).

In an IP telephony system, each of the communication terminals sends a SIP (Session Initiation Protocol) Register message (registration request) to an SIP (Session Initiation Protocol) server, and the SIP server pre-registers the SIP Register information such as a terminal connecting location etc in a subscriber database (DB) on the basis of this message. Then, the SIP server, when receiving a call setup request (INVITE) from a caller communication terminal (SIPUA), relays the call setup request to a callee communication terminal on the basis of the information in the subscriber DB, and controls (relays) the call to set up the call between these communication terminals.

Further, the SIP server registers phone numbers of the terminals and other SIP servers controlling the calls of the terminals in a way that associates the phone numbers and the SIP servers with each other, and, when receiving the call setup request about the phone number of the terminal controlled by the other SIP server, relays a signal of the call setup request to the other SIP server.

Moreover, for instance, a technology disclosed in the following Patent document 1 is given as a prior art related to the invention of the present application.

[Patent document 1] Japanese Patent Application Laid-Open Publication No. 2005-124060

### SUMMARY OF THE INVENTION

In the conventional IP telephony system, the SIP Register information of each communication terminal is registered in a specified SIP server. In a mobile communication terminal proposed over the recent years, a connecting location to a network changes as a user moves, and hence, if configured to register the SIP Register information in the specified SIP server, a call process becomes inefficient in the case of moving (visiting) to a location far away from the SIP server.

For example, a receiving call targeted at the terminal of which the SIP Register information is registered in the SIP server in Tokyo is invariably set up via this SIP server in Tokyo. Accordingly, as shown in FIG. 1, a terminal 602 of which the SIP Register information is registered in the SIP server 101 in Tokyo moves to (visits) Osaka and receives an incoming call from a terminal 603 in Osaka, in which case also the call is transferred via the SIP server 101 in Tokyo, and therefore a traffic between Tokyo and Osaka becomes futile.

Such being the case, the invention schemes to set up the call at the high efficiency in the way that the location management device notifies the call control device of the call setup request, which corresponds to (covers) the location of the callee communication device.

The invention adopts the following configurations in order to solve the problems.

Namely, a call system according to the invention includes a location management device and a plurality of call control devices that are connected via a network,

the call control device comprising:

a receiving unit receiving a call setup request;

a search unit searching a location data table for location information of a callee communication device in response to the call setup request received by the receiving unit;

a call control unit setting up, when the location information is searched out as a result of the search, a call on the basis of the location information; and

a notifying unit notifying, when the location information is not searched out as the result of the search, the location management device of the call setup request,

the location management device comprising:

a storage unit stored with management information specifying which call control device controls the call targeted at each callee communication device;

a call receiving unit receiving notification of the call setup request from the call control device; and

a notifying unit referring to the storage unit and notifying, of the call setup request, the call control device that controls the call to the callee communication device at which the call setup request is targeted.

In the call system, the location information may be hierarchically managed by storing the storage unit with the management information about the communication device existing in a predetermined area and by providing the plurality of location management devices stored with management information on different areas and a wide area management device managing the location information in a way that specifies which location management device in the plurality of location management devices is stored with the management information of each of the communication devices.

The wide area management device may include a storage unit stored with subscriber information of each communication device, and the location management device may include an acquiring unit acquiring, from the wide area management device, the subscriber information of the communication device related to the management information stored in the storage unit.

The location management device may include a wide area notifying unit receiving the notification of the call setup request from the call control device and, if the storage unit is not stored with the management information about the callee communication device at which the call setup request is targeted, notifying the wide area management device of the call setup request, and

the wide area management device may include:

a storage unit stored with wide area management information specifying which location management device in the plurality of location management devices is stored with the management information of each of the communication device;

a call receiving unit receiving notification of the call setup request from the location management device; and

a notifying unit referring to the storage unit, specifying the location management device stored with the management information of the callee communication device at which the call setup request is targeted, and notifying the location management device of the call setup request.

Further, a call method according to the invention is a method by which a call control device connected to a location management device via a network executes:

receiving a call setup request;

searching a location data table for location information of a callee communication device in response to the call setup request;

setting up, when the location information is searched out as a result of the search, a call on the basis of the location information; and

notifying, when the location information is not searched out as the result of the search, the location management device of the call setup request,

and by which the location management device executes:

receiving notification of the call setup request from the call control device;

referring to a storage unit stored with management information specifying which call control device controls the call targeted at each callee communication device; and

notifying, of the call setup request, the call control device that controls the call to the callee communication device at which the call setup request is targeted on the basis of the management information referred to.

In the call method, the location information may be hierarchically managed by the location management device's storing the storage unit with the management information about the communication device existing in a predetermined area and by the wide area management device's managing the location information in a way that specifies which location management device in the plurality of location management devices stored with management information on different areas is stored with the management information and specifies which communication device whose management information is stored.

In the call method, the wide area management device may store a storage unit with subscriber information of each communication device, and

the location management device may acquire, from the wide area management device, the subscriber information of the communication device related to the management information stored in the storage unit.

In the call method, the location management device may receive the notification of the call setup request from the call control device and, if the storage unit is not stored with the management information about the callee communication device at which the call setup request is targeted, notify the wide area management device of the call setup request, and

the wide area management device may store a storage unit with wide area management information specifying which location management device in the plurality of location management devices is stored with the management information of each of the communication device, receive notification of the call setup request from the location management device, then specify the location management device stored with the management information of the callee communication device at which the call setup request is targeted by referring to the storage unit, and notify the location management device of the call setup request.

Moreover, according to the invention, a call control device connected to a location management device via a network, comprises:

a receiving unit receiving a call setup request;

a search unit searching a location data table for location information of a callee communication device in response to the call setup request received by the receiving unit;

a call control unit setting up, when the location information is searched out as a result of the search, a call on the basis of the location information; and

a notifying unit notifying, when the location information is not searched out as the result of the search, the location management device of the call setup request.

Still further, a call method according to the invention is a method by which a call control device connected to a location management device via a network executes:

receiving a call setup request;

searching a location data table for location information of a callee communication device in response to the call setup request;

setting up, when the location information is searched out as a result of the search, a call on the basis of the location information; and

notifying, when the location information is not searched out as the result of the search, the location management device of the call setup request.

Yet further, according to the invention, a location management device connected to a call control device via a network, comprises:

a storage unit stored with management information specifying which call control device controls the call targeted at each callee communication device;

a call receiving unit receiving notification of the call setup request from the call control device; and

a notifying unit referring to the storage unit and notifying, of the call setup request, the call control device that controls the call to the callee communication device at which the call setup request is targeted.

Additionally, a call method according to the invention is a method by which a location management device connected to a call control device via a network, executes:

receiving notification of a call setup request from the call control device;

referring to a storage unit stored with management information specifying which call control device controls the call targeted at each callee communication device; and

notifying, of the call setup request, the call control device that controls the call to the callee communication device at which the call setup request is targeted on the basis of the management information referred to.

Moreover, the invention may also be a program for making a computer execute the call method. Further, the invention may also be a readable-by-computer storage medium stored with this program. The computer is made to read and execute the program on this storage medium, thereby enabling functions thereof to be provided.

Herein, the storage medium readable by the computer connotes a storage medium capable of storing information such as data, programs, etc electrically, magnetically, optically, mechanically or by chemical action, which can be read from the computer. Among these storage mediums, for example, a flexible disc, a magneto-optic disc, a CD-ROM, a CD-R/W, a DVD, a DAT, an 8 mm tape, a memory card, etc. are given as those demountable from the computer.

Further, a hard disc, a ROM (Read-Only Memory), etc. are given as the storage mediums fixed within the computer.

### EFFECTS OF THE INVENTION

According to the invention, it is possible to provide a technology enabling the call to be set up at the high efficiency in the way that the location management device notifies the call control device of the call setup request, which corresponds to the location of the callee communication device.

### BRIEF DESCRIPTION OF THE DRAWINGS

FIG. 1 is a diagram showing a problem of the related art.

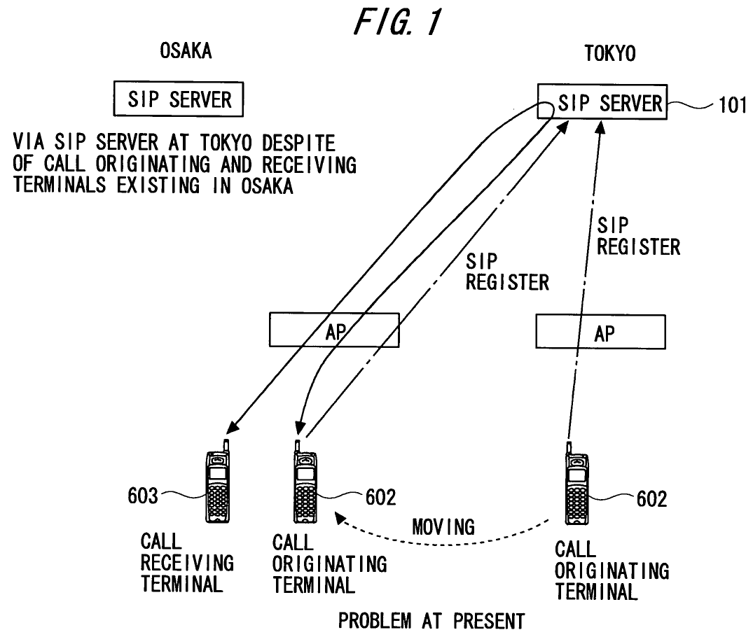

FIG. 2 is a diagram showing the whole of the invention.

FIG. 3 is a functional block diagram of a relay node.

FIG. 4 is a functional block diagram of an LLM.

FIG. 5 is a functional block diagram of an NLM.

FIG. 6 is a functional block diagram of an SIP server.

FIG. 7 is a functional block diagram of a communication device.

FIG. 8 is a diagram showing a connecting relation of the device provided in each area.

FIG. 9 is a diagram showing a process in which the relay node notifies the LLM of terminal information.

FIG. 10 is a sequence diagram of notifying of SIP Register information.

FIG. 11 is a sequence diagram of registering the SIP Register information.

FIG. 12 is a sequence diagram of setting up a call.

FIG. 13 is a sequence diagram when canceling the connection of the terminal.

FIG. 14 is a sequence diagram when canceling the connection of the terminal.

FIG. 15 is an explanatory diagram when acquiring subscriber information.

### DETAILED DESCRIPTION OF THE PREFERRED EMBODIMENT

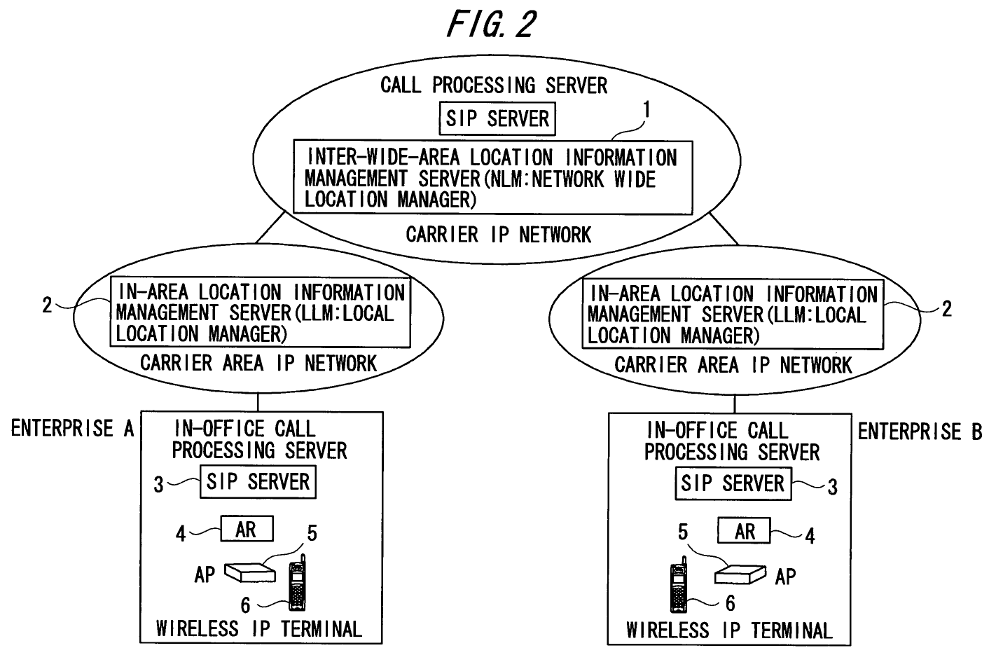

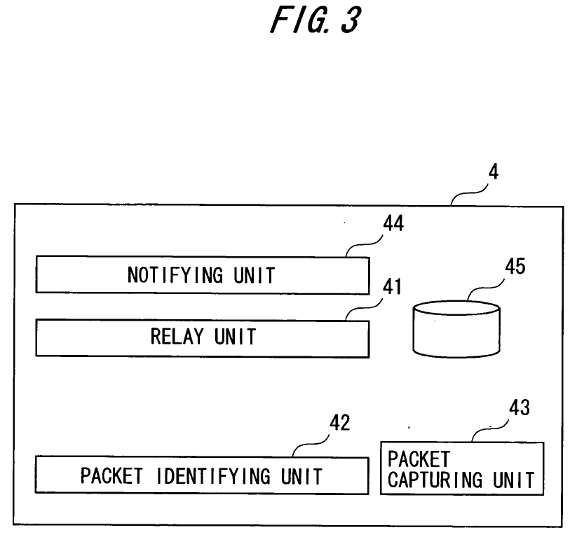

FIG. 2 is a schematic diagram of an IP telephony system (mobile call system) according to the invention, and FIGS. 3 through 6 are block diagrams showing respective components configuring the IP telephony system.

An IP telephony system 10 in this example includes a wide area location management device (Network wide Location Manager: NLM) 1, an in-area location management device (Local Location Manager: LLM) 2, a SIP server (call control device) 3, and an access router (relay node) 4.

In the IP telephony system 10 in the embodiment, each terminal registers the SIP server 3 of a visited location with SIP Register information containing location information, the LLM 2 is stored with management information specifying which terminal's (communication device's) SIP Register information is registered in the SIP server 3 provided in a predetermined area, and the NLM 1 is stored with wide area management information specifying which terminal's management information is stored in each LLM. Namely, the SIP server 3, the LLM 2 and the NLM 1 are hierarchically stored with the location information (SIP Register information) of each terminal 6.

Then, the terminal 6 sets up a call in the SIP server 3 of the visited location. At this time, if the SIP server 3 is not registered with a callee terminal requested by the terminal 6, the SIP server 3 notifies the high-order LLM 2 of the call setup request. The LLM 2, if stored with the management information of the callee terminal, gives notification of the call setup request to the SIP server 3 registered with the callee terminal 6 on the basis of the management information, and gets the call setup to be done. Further, the LLM 2, whereas if not stored with the management information of the callee terminal, notifies the high-order NLM 1 of the call setup request.

The NLM 1 receiving the call setup request notifies the LLM 2 of the call setup request, which is stored with the management information of the callee terminal, on the basis of the wide area management information, and gets the call setup to be done in the way described above.

Thus, the IP telephony system in the embodiment is that the SIP server 3 corresponding to (covering) the location of the terminal 6 is notified of the call setup request and is made to set up the call at a high efficiency.

Given next are specific explanations of the respective components configuring the IP telephony system in the embodiment.

FIG. 3 is an explanatory diagram showing the access router 4. The access router 4 includes a relay unit 41, a packet identifying unit 42, a packet capturing unit 43, a notifying unit 44, and a storage unit (memory) 45.

The relay unit 41 relays a packet to be transmitted from the terminal 6 to the SIP server 3 and to other computers. The relay unit 41 in this example is a routing unit for routing the packet to other networks. A configuration in the embodiment is, it should be noted, that a network to which the terminal 6 is connected via an access point 5 is differentiated from a network to which the SIP server 3 belongs, and the packet sent from the terminal 6 to the SIP server 3 passes through this relay unit 41.

The packet identifying unit 42 identifies a predetermined packet in the packets relayed by the relay unit 41. For instance, in the embodiment, the packet identifying unit 42 identifies the packet which the terminal 6 requests the SIP server 3 to register (REGISTER).

The packet capturing unit 43 captures (extracts) SIP Register information from the registration request packet identified by the packet identifying unit 42.

The notifying unit 44 notifies the LLM 2 of the SIP Register information captured by the packet capturing unit 43. In this example, a destination (IP address) of the packet is used as apiece of identifying information of the SIP server 3. The identifying information of the SIP server 3 is not limited to this IP address and may also be such items of information capable of specifying the SIP server 3 in which the terminal 6 registers the SIP Register information, as a computer name of the SIP server, a network name (SSID (Service Set ID) etc) of the network to which the terminal connects and a district name (Tokyo, Osaka, etc). Further, the terminal 6 may send the identifying information of the SIP server 3 to the SIP server 3 in a way that contains this identifying information in the SIP Register information, and the access router 4 may transmit the SIP Register information containing this identifying information to the LLM 2.

The storage unit 45 has a data table in which to record connecting information of the communication terminal 6 connecting to the network.

The access router 4 in the embodiment is configured by the respective units constructed of pieces of hardware (electronic circuits) but may take, without being limited to this hardware construction, a configuration in which a computer (an information processing device) actualizes the functions of the individual units according to software (a communication program of the invention).

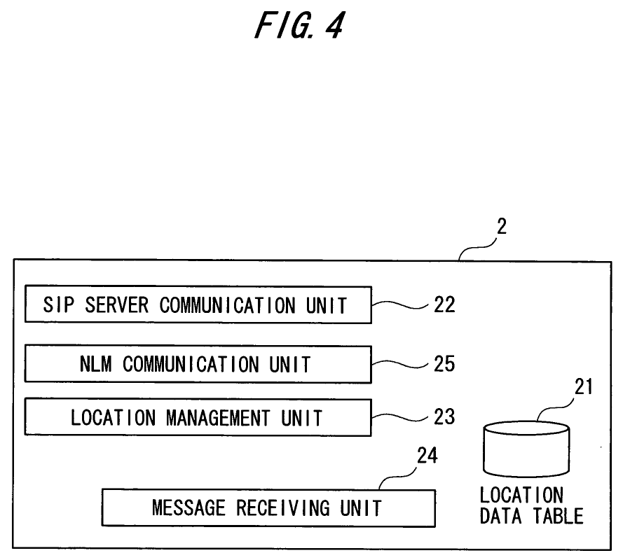

FIG. 4 is a functional block diagram of the LLM 2. The LLM 2 is a general-purpose computer including an arithmetic processing unit (a CPU etc) and a storage unit (a hard disc, a RAM, etc) 21. The storage unit 21 is preinstalled with programs such as Operating System (OS) and application software and is stored with a location data table that retains the management information showing which call control device controls the call targeted at each communication device as a callee.

Then, in the LLM 2, the arithmetic processing unit executes the process according to the program preinstalled into the storage unit 21. The arithmetic processing unit is, as shown in FIG. 4, thereby made to function as an SIP server communication unit (corresponding to a call receiving unit) 22, a location management unit (corresponding to a notifying unit) 23, a message receiving unit 24 and an NLM communication unit (acquiring unit) 25.

The SIP server communication unit 22 is notified of the call setup request from the SIP server 3.

The message receiving unit (management information registering unit) 24 receives from the access router 4 a piece of information (an IP address etc) that specifies the SIP server 3 controlling the call targeted at each terminal 6 as a callee, and stores the location data table of the storage unit 21 with the SIP Register information and the information specifying the SIP server 3 as the management information in a way that associates these items of information with each other.

The location management unit 23 searches for the SIP server 3 controlling the call targeted at the callee terminal 6 with the setup request received from the SIP server 3 by referring to the management information in the storage unit 21, and notifies the SIP server 3 of the call setup request via the SIP server communication unit 22.

Further, the location management unit 23 monitors a valid period of the management information and, when reaching this valid period, deletes the management information out of the location data table.

The NLM communication (acquiring unit) unit 25 acquires, from the NLM 1, subscriber information of the terminal 6 associated with the management information stored in the storage unit 21. Further, the NLM communication unit 25 sends to the NLM the information about the terminal managed by the LLM 2 itself.

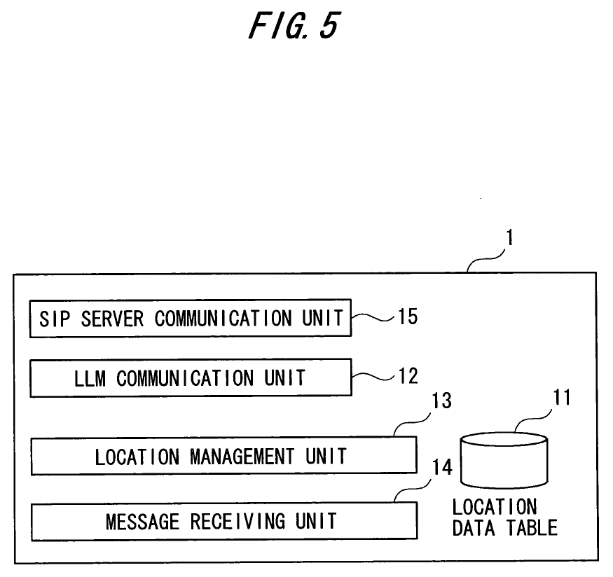

FIG. 5 is a functional block diagram showing the NLM 1. The NLM 1 is a general-purpose computer including an arithmetic processing unit (a CPU etc) and a storage unit (a hard disc, a RAM, etc) 11. The storage unit 11 is preinstalled with programs such as Operating System (OS) and application software and is stored with a location data table that retains subscriber information of each terminal 6 and wide area management information.

Then, in the NLM 1, the arithmetic processing unit executes the process according to the program preinstalled into the storage unit 11. The arithmetic processing unit is, as shown in FIG. 5, thereby made to function as an LLM communication unit (corresponding to a call receiving unit) 12, a location management unit (corresponding to a notifying unit) 13, a message receiving unit 14 and an SIP server communication unit 15.

The LLM communication unit 12 receives notification of the call setup request from the LLM 2.

The location management unit 13 specifies the LLM 2 stored with the management information of the recipient communication device of the call setup request received form the LLM 2 by referring to the storage unit, and notifies the LLM 2 of the call setup request.

The message receiving unit (including a management information registration unit) 14 receives the management information of each terminal 6 from the LLM 2 each stored with this management information, and the storage unit 11 retains the management information and information (IP address etc) specifying which LLM in the plurality of LLMs 2 is stored with this management information as the wide area management information in a way that associates these items of information with each other.

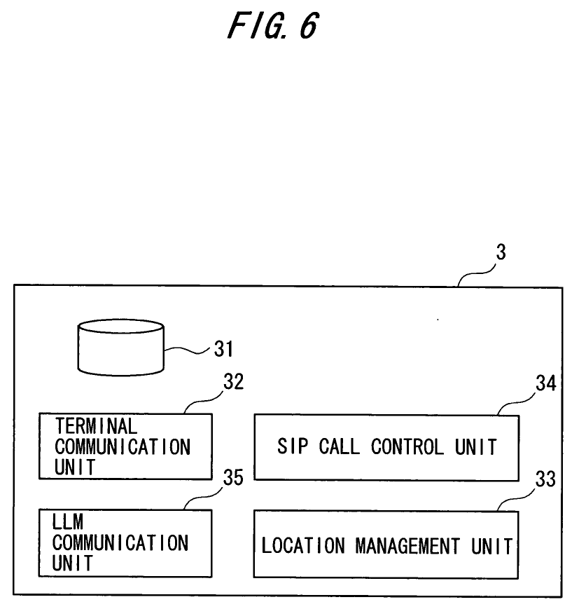

FIG. 6 is a functional block diagram of the SIP server 3. The SIP server 3 is a general-purpose computer including an arithmetic processing unit (a CPU etc) and a storage unit (a hard disc, a RAM, etc) 31. The storage unit 31 is preinstalled with programs such as Operating System (OS) and application software and is stored with a location data table (SIP Register) that retains SIP Register information containing the location information of each of the terminals 6.

Then, in the SIP server 3, the arithmetic processing unit executes the process according to the program preinstalled into the storage unit 31. The arithmetic processing unit is, as shown in FIG. 6, thereby made to function as a terminal communication unit (receiving/transmitting unit) 32, a location management unit (corresponding to a searching unit) 33, an SIP call control unit 34, and an LLM communication unit (corresponding to a notifying unit) 35.

The terminal communication unit 32 receives the call setup request and a registration request of the SIP Register information (REGISTER) from the terminal 6, and transmits the call setup request (INVITE) to the terminal 6.

The location management unit 33 performs the location information management such as searching the location data table for the location information of the callee terminal 6 in response to the call setup request received by the terminal communication unit 32 and deleting, from the location data table, the location information of the terminal 6 of which the call control becomes unnecessary (i.e., notification of deletion is given).

The SIP call control unit 34, when the location information is searched out as a result of the search, controls the terminal communication unit 32, and sets up the call by making the callee terminal 6 send the call setup request (INVITE) on the basis of the location information.

The LLM communication unit 35, when the location information is not searched out as a result of the search, notifies the LLM 2 of the call setup request.

In the NLM 1 and the LLM 2 in the embodiment, the functions of the respective units are actualized by the arithmetic processing unit according to the program (software), however, without being limited to this scheme, such a configuration may also be taken that the functions of the individual units are executed by employing the hardware (the electronic circuits) as these units.

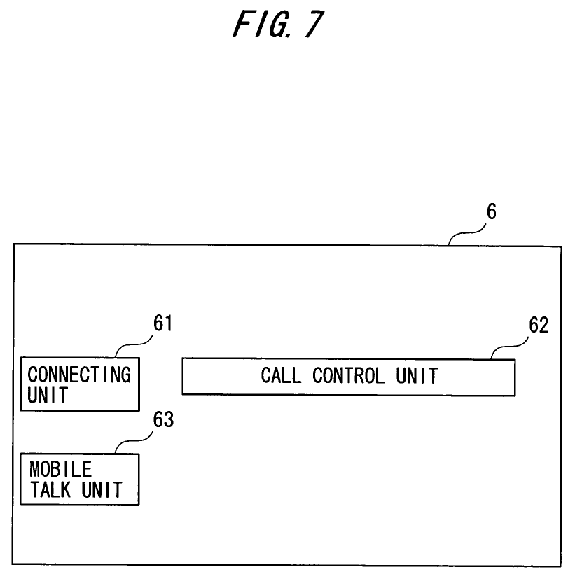

FIG. 7 is a functional block diagram of the terminal 6. The terminal 6 includes a connection unit 61, a call control unit 62 and a mobile talk unit 63.

The connection unit 61 is connected to a network such as a LAN etc, and controls the communications with other computers. In the embodiment, the connection unit 61 is a wireless LAN interface connecting to a wireless LAN access point 5 through radio waves defined by IEEE802.11g, Bluetooth (registered trademark) etc.

The call control unit 62 sends the registration request of the SIP Register information and the call setup request to the SIP server 3 via the connection unit 61. Further, the call control unit 62, when receiving the call setup request, sets up the call via the SIP server 3 or directly with the caller terminal 6.

The mobile talk unit 63 transmits and receives a voice packet through the call established based on the SIP, thus talking with the communication partner terminal.

In the embodiment, the respective units of the terminal 6 are constructed of the hardware (electronic circuits), however, without being limited to this construction, such a configuration may also be taken that the computer (the information processing device) actualizes the function of the individual units on the basis of the software (a communication program according to the invention).

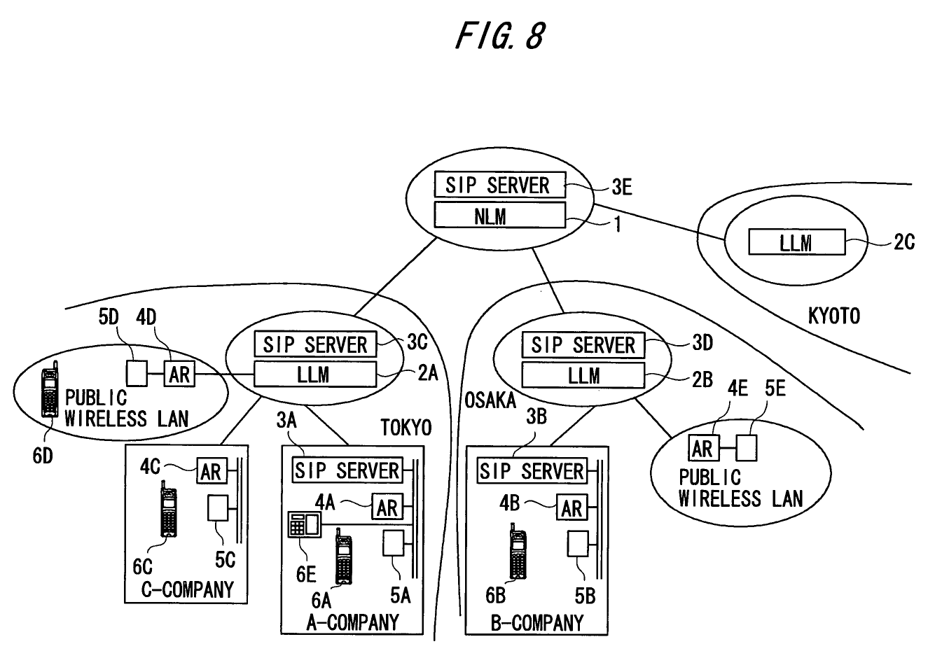

In the IP telephony system configured by those devices in the embodiment, a method of conducting the mobile talk (call) between the terminals will be exemplified with reference to FIGS. 8 through 15. Note that in the embodiment, for instance, when explaining items common to the respective devices with respect to the plurality of devices as in the case of the SIP servers 3, the device (SIP server) is designated by only the generic numeral “3”, and, when giving the explanation by specifying the individual devices, these devices (SIP servers) are represented by making them with specific symbols such as 3A, 3B and so on.

FIG. 8 is a diagram showing a connecting relation between the LLM 2 provided in a different district such as Tokyo and Osaka and the terminal 6 etc.

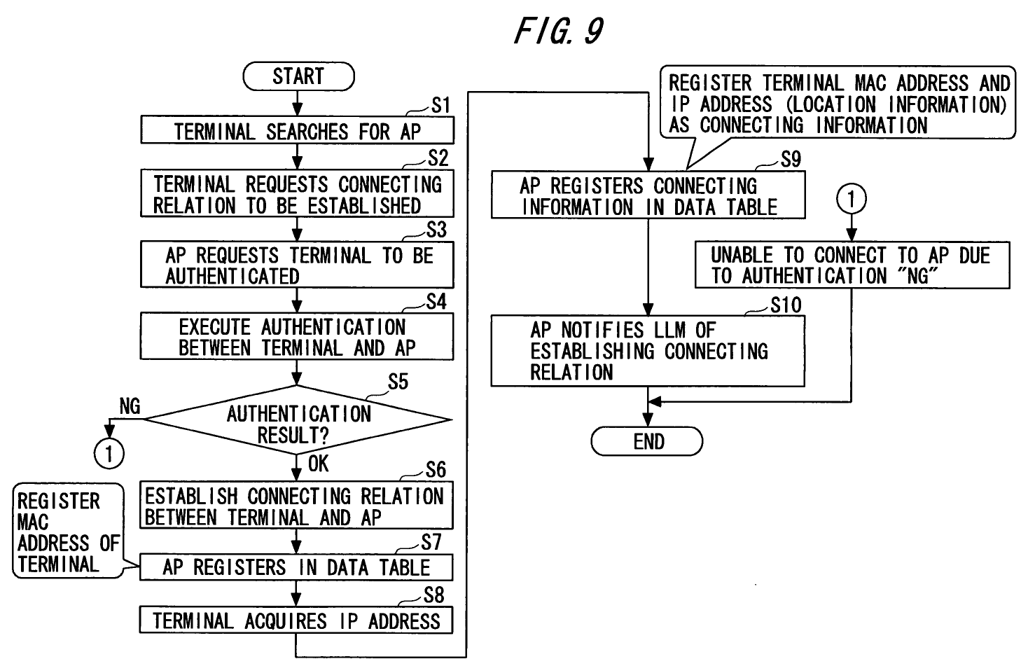

To begin with, a sequence on such an occasion that the terminal 6 connects to the network will be explained with reference to FIG. 9.

when the terminal 6 enters the wireless area covered by the access router 4 as a user carrying the terminal 6 moves, the terminal 6 sends an association request to the access point 5 in order to establish the connecting relation through the connecting unit 61 by searching for the access point 5 (step 1, which will herein after also be abbreviated such as S1) (S2).

In response to this request, the access point 5 requests the terminal 6 for authentication information such as an ID and an authentication key (S3). Upon receiving the authentication information from the terminal 6, the access point 5 authenticates the terminal 6 on the basis of the authentication information (S4-S5).

When the authentication of the terminal 6 is passed, the access point 5 establishes the connecting relation with the terminal 6 (S6), and registers the terminal information (MAC address etc) in the data table (S7).

The terminal 6, when connecting to the access point 5, acquires an IP address from the access router 4 by use of DHCP (Dynamic Host Configuration Protocol), thereby coming to an IP communication enabled status (S8).

At this time, the access router 4 registers the data table (a routing table etc) with the IP address acquired by the terminal 6, i.e., the on-network location information of the terminal 6 and the identifying information (the MAC address in this example) of the terminal 6 (S9). The relay unit 41 of the access router 4 relays the communications related to the terminal 6 on the basis of the information in this data table. Note that the relay unit 41, if there is no communication from the terminal 6 for a predetermined period of time (when the valid period expires), deletes the information about the terminal 6 from the data table. Therefore, the relay unit 41 can judge that the terminal keeps connecting to the network if the information (which is also called the connecting information) is stored in the data table and that the terminal 6 does not connect to the network if the connecting information is not stored.

After registering the MAC address and the IP address, the notifying unit 44 of the access router 4 associates the MAC address and the IP address of the terminal and an IP address of the access router 4 with each other, and notifies the LLM 2 of these pieces of address information as the connecting information with respect to the terminal 6 (S10).

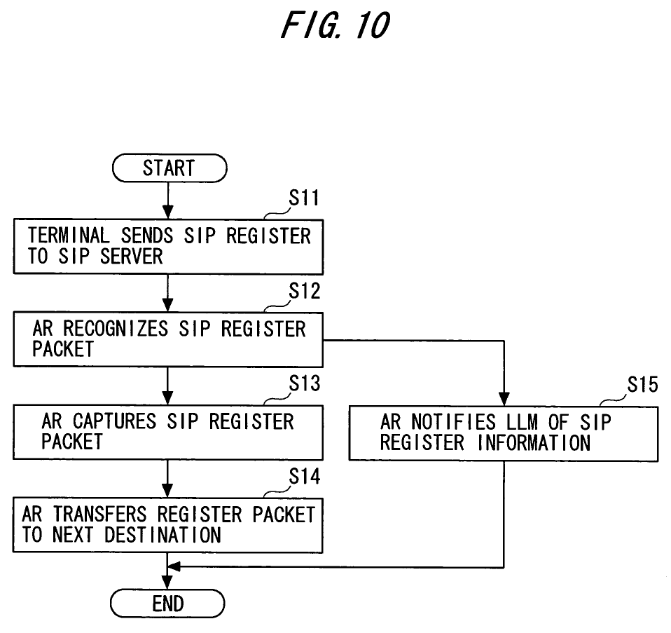

Next, a sequence starting with capturing the SIP Register of the terminal 6 by the access router 4 and ending with notifying the LLM 2 of the SIP Register, will be explained with reference to FIG. 10.

The terminal 6, when connecting to the network (the access point 5), sends a SIP Register message (REGISTER) defined as a location registration request to the SIP server 3 (S11).

Hereat, the terminal 6 detects the self-connected network and sends the SIP Register message to the SIP server 3 corresponding to (covering) this network. Namely, the terminal 6 sends the SIP Register message to the SIP server 3 corresponding to (covering) the network of the visited location. For instance, the terminal 6, when connecting to the access points 4, 4A, acquires the network identifying information such as an SSID and an ESSID (Extended Service Set Identifier) by the search in step 1, and sends the SIP Register message to the preset SIP server associated with the acquired network identifying information.

In the access router 4 relaying the packet from the terminal 6, the packet identifying unit 42 identifies the packet received from the terminal 6, and, when judging that this packet is the SIP Register message (S12), the packet capturing unit 43 captures and analyzes the SIP Register message (S13).

In the access router 4, the relay unit 41 processes the packet defined as the SIP Register message as usual and relays the processed packet to the destination (SIP server 3) (S14), and the notifying unit 44 notifies the LLM 2 of the IP address of the terminal 6, the SIP-URI of the terminal 6, the valid period (expire time) and the address of the SIP server 3 as SIP Register information (S15).

Moreover, in the SIP server 3, the location management unit 33 registers the Register information in the location data table on the basis of the SIP Register message received from the access router 4 in step 14. Note that the valid period is set in the Register information, and the location management unit 33 monitors the valid period of the Register information and, when the valid period expires, deletes the Register information from the location data table.

On the other hand, the terminal 6, before the registered SIP Register information expires, periodically sends the SIP Register message to the SIP server 3.

An example in FIG. 8 is that terminals 6A, 6E send the SIP Register messages to an SIP server 3A, a terminal 6B sends the SIP Register message to an SIP server 3B, and terminals 6C, 6D send the SIP Register messages to an SIP server 3C, respectively.

Further, access routers 4A, 4C, 4D send the SIP Register information to an LLM 2A, and access routers 4B, 4E send the SIP Register information to an LLM 2B, respectively.

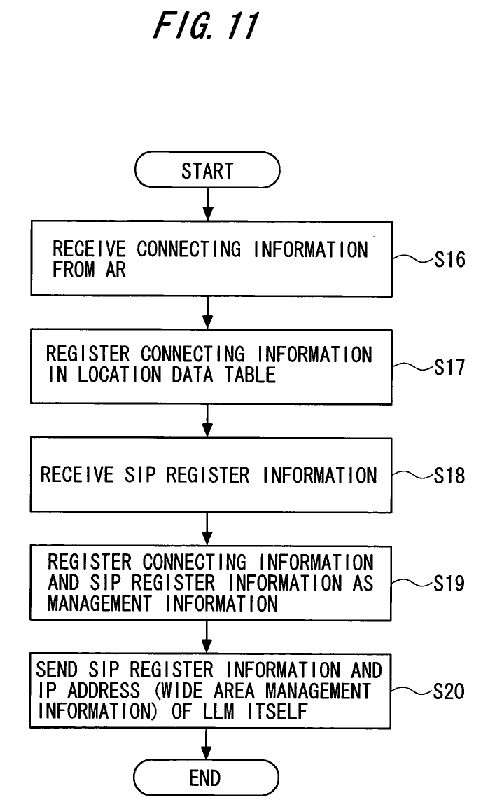

Moreover, in the LLM 2, as shown in FIG. 11, the message receiving unit 24 receives the connecting information from the access router 4 in step 10 (S16), and the location management unit 23 registers the connecting information in the location data table (S17). Further, when receiving the SIP Register message in step 15 (S18), the location management unit 23 associates the connecting information containing an IP address coincident with the IP address of the terminal 6 with the SIP Register information, and registers these items of information as the management information in the location data table (S19). It is to be noted that the valid period is set in the management information, and the location management unit 23 monitors the valid period of the management information and, when reaching the valid period, deletes the management information from the location data table.

Further, when receiving the SIP Register information, the NLM communication unit 25 transmits, to the NLM 1, the wide area management information showing that the LLM 2 is stored with the SIP Register information and the management information of the terminal 6 associated with the IP address of the LLM 2 itself, i.e., the SIP Register information (S20).

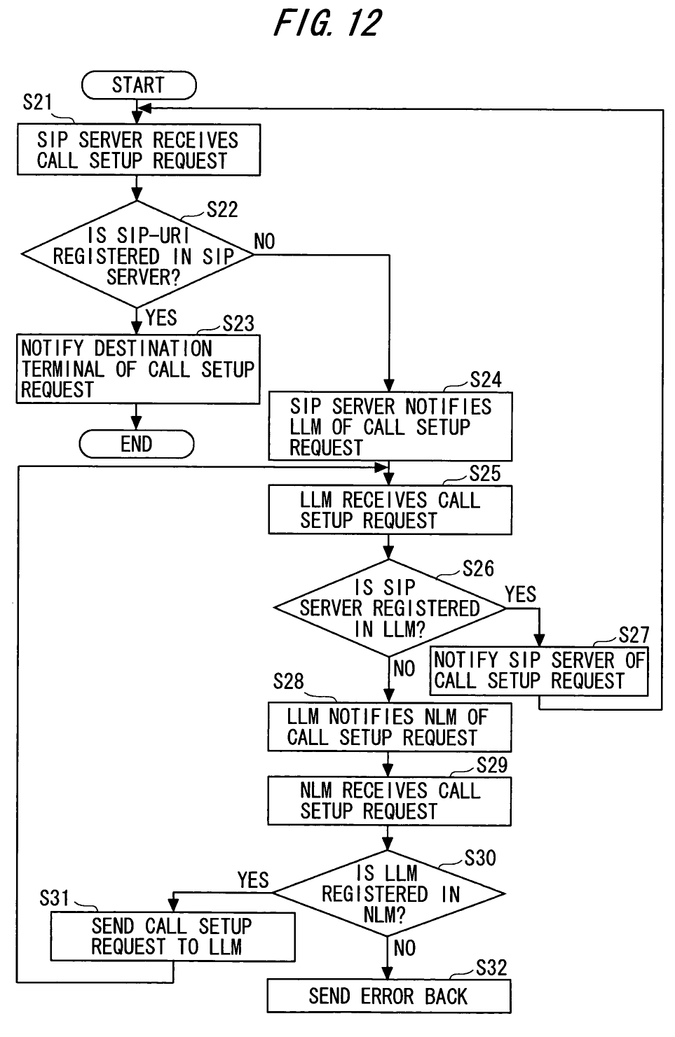

While on the other hand, when the user of the terminal 6 designates a phone number and dials this phone number, as shown in FIG. 12, the SIP server 3 receives a call setup request (INVITE) targeted at the callee's SIP-URI associated with this phone number (S21). For example, when the terminal 6A shown in FIG. 8 telephones the terminal 5E, the terminal 6A sends the call setup request (INVITE) targeted at the callee terminal 6E to the SIP server 3A.

The SIP server 3 receiving the callee's SIP-URI searches through the location data table and thus checks whether or not this SIP-URI is registered therein (S22). Then, if registered, the call is set up by sending the call setup request to the callee terminal 6 on the basis of the location information associated with the SIP-URI (S23). Namely, the SIP server 3A is registered with the SIP-URI of the callee terminal 6E and therefore sends the call setup request to the callee terminal 6E on the basis of the IP address (location information) associated with this SIP-URI.

Thus, if the SIP Register information about both of the caller terminal 6A and the callee terminal 6E is registered in the SIP server 3A, the call is set up via this in-office SIP server 3A.

On the other hand, when the terminal 6A sends the call setup request targeted at the off-office callee terminal 6C to the SIP server 3A (S21), the SIP server 3A searches through the location data table by employing the location management unit 23 (S22), and judges that the callee's SIP-URI is not registered, i.e., this call is not a call that should be controlled by the SIP server 3A itself.

Then, the LLM communication unit 35 gives the notification of the call setup request to a just-above LLM 2, i.e., the LLM 2A in Tokyo (S24).

The LLM 2, when receiving the call setup request from the SIP server 3 (S25), refers to the management information in the location database stored in the storage unit 21, thus searching for the SIP server 3 that controls the callee terminal (S26). In the embodiment, the LLM 2 searches for the SIP-URI coincident with the callee's SIP-URI and acquires the address of the SIP server 3 so stored as to be associated with the this SIP-URI from the location database. For instance, the LLM 2A, when notified of the call setup request targeted at the callee terminal 6C, reads from the location database an IP address of the SIP server 3C associated with the SIP-URI of the terminal 6C.

In the case of acquiring the SIP server 3 that controls the call, the LLM 2 notifies the SIP server 3 of the call setup request (S27). To be more specific, the LLM 2A notifies the SIP server 3C of this call setup request.

The SIP server 3 receiving the call setup request from the LLM 2 (S21) searches through the location data table and checks whether the SIP-URI concerned is registered or not (S22). Then, if registered, the call setup request is sent to the terminal 6 having this registered SIP-URI to set up the call (S23). Namely, since the SIP server 3C is registered with the SIP-URI of the callee terminal 6C, the location information associated with this SIP-URI is acquired from the location data table, and the call setup request is sent to the callee terminal 6C on the basis of the location information.

Thus, even in the case of the call from the terminal 6A to the off-office terminal 6C, i.e., the call targeted at the terminal 6C unregistered in the SIP server 3A, if both of the terminals 6A and 6C exist in the same area (managed by the same LLM 2), the call can be controlled by the middle-order LLM 2A without querying the high-order NLM 1.

On the other hand, when the SIP server 3A receives the call setup request targeted at the callee terminal 6B in other area from the terminal 6A (S21), the SIP server 3 searches through the location data table by using the location management unit 33 (S22), and judges that the callee's SIP-URI is not registered therein, i.e., the call is not a call that should be controlled by the SIP server 3 itself.

Then, the LLM communication unit 35 gives the notification of the call setup request to the just-above LLM 2, i.e., the LLM 2A in Tokyo (S24).

The LLM 2, when receiving the call setup request from the SIP server 3 (S25), refers to the management information in the location database stored in the storage unit 21, thus searching for the SIP server 3 that controls the callee terminal of the call (S26).

As a result, if the management information related to the callee terminal is not searched out, the LLM 2 judges that the call is not a call that should be controlled by the LLM 2 itself, and the NLM communication unit 25 notifies the NLM 1 of the call setup request (S28).

The NLM 1, upon receiving the call setup request from the LLM 2 (S29), refers to the wide area management information in the location data table stored in the storage unit 11, thus searching for an address of the LLM 2 stored with the management information about the callee terminal of the call (S30). In the embodiment, the SIP-URI coincident with the callee's SIP-URI is retrieved, and the address of the LLM 2 that is stored in association with this SIP-URI is acquired from the location database. For instance, in the case of the call targeted at the callee terminal 6B, the IP address of the LLM 2B managing the SIP server 3B is obtained.

Then, the LLM 2 is notified of the call setup request on the basis of the thus-obtained address (S31).

In the case of receiving this call setup request from the NLM 1 (S25), the LLM 2 searches the location database for the IP address of the SIP server 3 associated with the SIP-URI of the terminal 6 in the same way as the above (S26).

Then, the LLM 2 notifies the SIP server 3 of the call setup request on the basis of the readout address (S27). To be more specific, the LLM 2B notifies the SIP server 3B controlling the call targeted at the callee terminal 6B.

The SIP server 3 receiving the call setup request from the LLM 2 (S21) searches through the location data table and checks whether the SIP-URI concerned is registered or not (S22). Then, if registered, the SIP server 3 sends the call setup request to the terminal 6 having this SIP-URI to set up the call (S23). Namely, as the SIP server 3B is registered with the SIP-URI of the callee terminal 6B, the location information associated with this SIP-URI is acquired from the location data table, and the call setup request is sent to the callee terminal 6B on the basis of the location information.

Thus, even in the case of the call setup request to the off-area terminal 6B from the terminal 6A, i.e., the call setup request targeted at the callee terminal 6B unregistered in the LLM 2A, the NLM 1 notifies the SIP server 3 of the call setup request, which has the management information of the callee terminal 6B, thereby enabling the call to be controlled.

On the other hand, in step 30, if the SIP-URI is not registered in the location data table of the NLM 1, the NLM 1 sends an error (message) back to the LLM 2, while the LLM 2 sends the error (message) back to the SIP server 3, and the SIP server 3 notifies the terminal 6 of the error (S32).

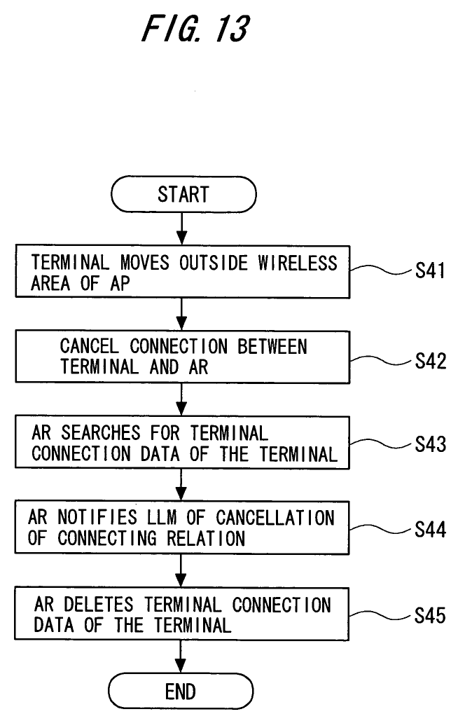

Next, FIG. 13 shows a sequence when canceling the connecting relation between the access router 4 and the terminal 6.

When the terminal 6 moves outside the wireless area of the access point 5 (S41) and if the transmission from the terminal 6 discontinues for a predetermined period of time, the relay unit 41 of the access router 4 judges that the connecting relation with the terminal 6 is canceled (S42).

Then, the relay unit 41 searches the data table (the routing table et.) for the information (the MAC address, the IP address, etc) that specifies the terminal 6 (S43).

The notifying unit 44 sends to the LLM 2 the information specifying the terminal 6 and the information showing the cancellation of the connecting relation as connecting status information (notification of disconnection of the terminal 6 (S44).

Then, the relay unit 41 deletes the information about the terminal 6 from the data table (S45).

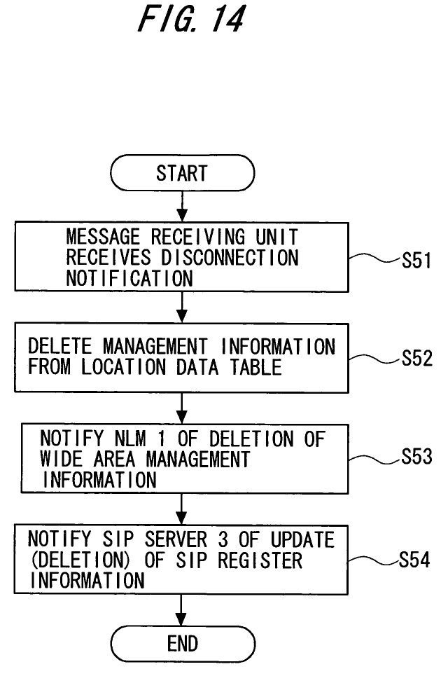

On the other hand, when the notification of disconnection is sent from the access router 4 in step 44, in the LLM 2, as shown in FIG. 14, the message receiving unit 24 receives the notification of disconnection (S51), and the location management unit 23 deletes the management information of the terminal 6 from the location data table (S52).

Moreover, the NLM communication unit 25 notifies the NLM 1 of the update (deletion) of the wide area management information (S53).

Further, the SIP server communication unit 22 notifies the SIP server 3 of the update (deletion) of the SIP Register information (S54).

In the NLM 1, when the LLM communication unit 12 receives the notification of deletion of this wide area management information, the location management unit 13 deletes the wide area management information from the data table.

Moreover, in the SIP server 3, when the LLM communication unit 35 receives the notification of deletion of this SIP Register information, the location management unit 33 deletes the SIP Register information from the data table.

As described above, in the call system in the embodiment, the location information is hierarchically managed, the call is set up via the LLM that manages (covers) this area if the caller terminal and the callee terminal exist in the same area, then the high-order device, i.e., the NLM is notified of the call setup request only if the caller terminal and the callee terminal do not exist in the same area, and it is therefore possible to set up the call at the high efficiency. Furthermore, a load applied on to the high-order device can be restrained.

### MODIFIED EXAMPLE 1

In the embodiment described above, in the case of setting up the call from the terminal 6A to the terminal 6C, the LLM 2A notifies the SIP server 3C of the call setup request, which has already been registered with the terminal 6C, however, without being limited to this scheme, the SIP server 3A may notify the terminal 6C of the call setup request by sending the location information of the terminal 6 C in response to the call setup request from the SIP server 3A.

### MODIFIED EXAMPLE 2

In the embodiment described above, the terminal 6 identifies the network and sends the SIP Register message (registration request) to the predetermined SIP server, however, without being limited to this scheme, such a configuration may also be taken that when the terminal 6 connects to the network, the device in the network gives the notification to the connected terminal 6. For example, the address of the SIP server provided in each of the areas is registered in the DHCP server, and, when the terminal connects to the network, the notification of the IP address of the SIP server is given by an option defined in RFC3361 (IPv4), RFC3319 (IPv6).

Note that the option is disclosed on the following Web pages, and hence the detailed explanation thereof is omitted.

http://www.faqs.org/rfcs/rfc3361.html (IPv4)
http://www.faqs.org/rfcs/rfc3319.html (IPv6)

### MODIFIED EXAMPLE 3

The LLM 2 may also be configured to acquire from the NLM 1 the information about each of the terminals managed by the LLM 2 itself.

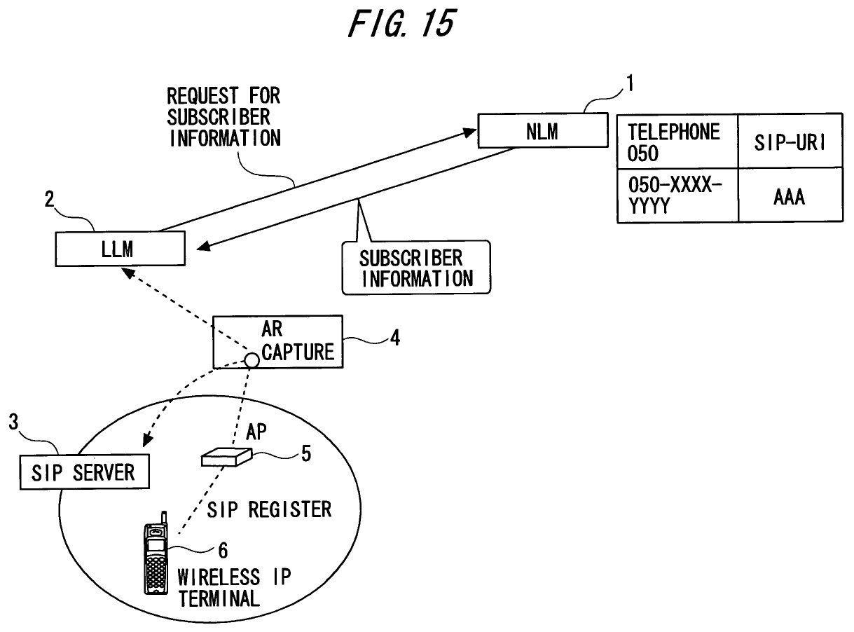

For instance, the SIP server 3A identifies the in-office terminal 6 with the SIP-URI based on the user name and registers the SIP Register information containing this SIP-URI in the LLM 2A, in which case the NLM communication unit 25 of the LLM 2A requests, as shown in FIG. 15, the NLM 1 for subscriber information (a phone number associated with the user name). In response to this request, the NLM 1 reads the subscriber information of the terminal from the storage unit 11 and notifies the LLM 2 of the subscriber information.

Then, the LLM 2 adds the subscriber information received from the NLM to the management information of this terminal 6.

With this addition, even if the SIP-URI differs depending on the company and the area, the LLM can manage the information.

Moreover, the subscriber information acquired by the LLM 2 from the NLM 1 may, without being limited to the phone number, also be information representing an accounting condition and showing whether a call hold and a transfer are permitted or not.

### MODIFIED EXAMPLE 4

The embodiment has exemplified the example of employing the access router as the relay node, however, without being limited to this scheme, the access point may capture (extract) the SIP Register information and notify the LLM of this SIP Register information.

Further, the SIP server 3 may also notify the LLM of the registered SIP Register information.

<Others>

The invention is not limited to only the illustrated examples given above and can be, as a matter of course, changed in a variety of forms in the range that does not deviate from the gist of the invention.

<Incorporation by Reference>

The disclosures of Japanese patent application No. JP2006-025651 filed on Feb. 2, 2006 including the specification, drawings and abstract are incorporated herein by reference.

What is claimed is:

1. A call system including a location management device and a plurality of call control devices that are connected via a network,
the call control device comprising:
a receiving unit receiving a call setup request;
a search unit searching a location data table for location information of a callee communication device in response to the call setup request received by the receiving unit;
a call control unit setting up, when the location information is searched out as a result of the search, a call on the basis of the location information; and
a notifying unit notifying, when the location information is not searched out as the result of the search, the location management device of the call setup request,
the location management device comprising:
a storage unit stored with management information specifying which call control device controls the call targeted at each callee communication device;
a call receiving unit receiving notification of the call setup request from the call control device; and
a notifying unit referring to the storage unit and notifying, of the call setup request, the call control device that controls the call to the callee communication device at which the call setup request is targeted.

2. A call system according to claim 1, wherein the location information is hierarchically managed by storing the storage unit with the management information about the communication device existing in a predetermined area and by providing the plurality of location management devices stored with management information on different areas and a wide area management device managing the location information in a way that specifies which location management device in the plurality of location management devices is stored with the management information of each of the communication devices.

3. A call system according to claim 2, wherein the wide area management device includes a storage unit stored with subscriber information of each communication device, and
the location management device includes an acquiring unit acquiring, from the wide area management device, the subscriber information of the communication device related to the management information stored in the storage unit.

4. A call system according to claim 2, wherein the location management device includes a wide area notifying unit receiving the notification of the call setup request from the call control device and, if the storage unit is not stored with the management information about the callee communication device at which the call setup request is targeted, notifying the wide area management device of the call setup request, and
the wide area management device includes:
a storage unit stored with wide area management information specifying which location management device in the plurality of location management devices is stored with the management information of each of the communication device;
a call receiving unit receiving notification of the call setup request from the location management device; and
a notifying unit referring to the storage unit, specifying the location management device stored with the management information of the callee communication device at which the call setup request is targeted, and notifying the location management device of the call setup request.

5. A call system according to claim 3, wherein the location management device includes a wide area notifying unit receiving the notification of the call setup request from the call control device and, if the storage unit is not stored with the management information about the callee communication device at which the call setup request is targeted, notifying the wide area management device of the call setup request, and
the wide area management device includes:
a storage unit stored with wide area management information specifying which location management device in the plurality of location management devices is stored with the management information of each of the communication device;
a call receiving unit receiving notification of the call setup request from the location management device; and
a notifying unit referring to the storage unit, specifying the location management device stored with the management information of the callee communication device at which the call setup request is targeted, and notifying the location management device of the call setup request.

6. A call method by which a call control device connected to a location management device via a network executes:
receiving a call setup request;
searching a location data table for location information of a callee communication device in response to the call setup request;
setting up, when the location information is searched out as a result of the search, a call on the basis of the location information; and
notifying, when the location information is not searched out as the result of the search, the location management device of the call setup request,
and by which the location management device executes:
receiving notification of the call setup request from the call control device;
referring to a storage unit stored with management information specifying which call control device controls the call targeted at each callee communication device; and
notifying, of the call setup request, the call control device that controls the call to the callee communication device at which the call setup request is targeted on the basis of the management information referred to.

7. A call method according to claim 6, wherein the location information is hierarchically managed by the location management device's storing the storage unit with the management information about the communication device existing in a predetermined area and by the wide area management device's managing the location information in a way that specifies which location management device in the plurality of location management devices stored with management information on different areas is stored with the management information and specifies which communication device whose management information is stored.

8. A call method according to claim 7, wherein the wide area management device stores a storage unit with subscriber information of each communication device, and
the location management device acquires, from the wide area management device, the subscriber information of the communication device related to the management information stored in the storage unit.

9. A call method according to claim 7, wherein the location management device receives the notification of the call setup request from the call control device and, if the storage unit is not stored with the management information about the callee communication device at which the call setup request is targeted, notifies the wide area management device of the call setup request, and
the wide area management device stores a storage unit with wide area management information specifying which location management device in the plurality of location management devices is stored with the management information of each of the communication device, receives notification of the call setup request from the location management device, then specifies the location management device stored with the management information of the callee communication device at which the call setup request is targeted by referring to the storage unit, and notifies the location management device of the call setup request.

10. A call control device connected to a location management device via a network, comprising:
a receiving unit receiving a call setup request;
a search unit searching a location data table for location information of a callee communication device in response to the call setup request received by the receiving unit;
a call control unit setting up, when the location information is searched out as a result of the search, a call on the basis of the location information; and
a notifying unit notifying, when the location information is not searched out as the result of the search, the location management device of the call setup request.

11. A call method by which a call control device connected to a location management device via a network executes:
receiving a call setup request;
searching a location data table for location information of a callee communication device in response to the call setup request;
setting up, when the location information is searched out as a result of the search, a call on the basis of the location information; and
notifying, when the location information is not searched out as the result of the search, the location management device of the call setup request.

12. A recording medium recorded with a program for making a call control device connected to a location management device via a network actualize functions of:
receiving a call setup request;
searching a location data table for location information of a callee communication device in response to the call setup request;
setting up, when the location information is searched out as a result of the search, a call on the basis of the location information; and
notifying, when the location information is not searched out as the result of the search, the location management device of the call setup request.

13. A location management device connected to a call control device via a network, comprising:
a storage unit stored with management information specifying which call control device controls the call targeted at each callee communication device;
a call receiving unit receiving notification of the call setup request from the call control device; and
a notifying unit referring to the storage unit and notifying, of the call setup request, the call control device that controls the call to the callee communication device at which the call setup request is targeted.

14. A call method by which a location management device connected to a call control device via a network, executes:
receiving notification of a call setup request from the call control device;
referring to a storage unit stored with management information specifying which call control device controls the call targeted at each callee communication device; and
notifying, of the call setup request, the call control device that controls the call to the callee communication device at which the call setup request is targeted on the basis of the management information referred to.

15. A recording medium recorded with a program for making a location management device connected to a call control device via a network, actualize functions of:
receiving notification of a call setup request from the call control device;
referring to a storage unit stored with management information specifying which call control device controls the call targeted at each callee communication device; and
notifying, of the call setup request, the call control device that controls the call to the callee communication device at which the call setup request is targeted on the basis of the management information referred to.
